(19) United States
(12) Patent Application Publication
(10) Pub. No.: US 2021/0278998 A1
(43) Pub. Date: Sep. 9, 2021

(54) ARCHITECTURE AND DESIGN OF A STORAGE DEVICE CONTROLLER FOR HYPERSCALE INFRASTRUCTURE

(71) Applicant: Alibaba Group Holding Limited, George Town (KY)

(72) Inventor: Shu Li, Bothell, WA (US)

(73) Assignee: Alibaba Group Holding Limited, George Town (KY)

(21) Appl. No.: 16/813,449

(22) Filed: Mar. 9, 2020

(51) Int. Cl. G06F 3/06; G06F 12/10; G06F 13/16; G06F 11/10

(52) U.S. Cl. CPC G06F 3/0659; G06F 3/0604; G06F 3/0679; G06F 2212/657; G06F 13/1668; G06F 11/1068; G06F 12/10

(57) ABSTRACT

An apparatus is provided to facilitate a hyperscale infrastructure. The apparatus comprises a non-volatile memory and a controller. The controller comprises: a memory interface coupled to a first memory; a media interface coupled to the non-volatile memory; a media controller associated with the media interface; a hardware accelerator configured to process, via the memory interface, data to be written to the non-volatile memory; and a reprogrammable hardware component configured to further process the data via the memory interface. The media controller is configured to write, via the media interface, the data to the non-volatile memory system.

### BACKGROUND

### Field

This disclosure is generally related to the field of data storage. More specifically, this disclosure is related to the architecture and design of a storage device controller for hyperscale infrastructure.

### Related Art

Today, various storage systems are being used to store and access the ever-increasing amount of digital content. A storage system can include storage servers with one or more storage devices or drives, and a storage device or drive can include storage media with a non-volatile memory (such as a solid state drive (SSD) or a hard disk drive (HDD)). A storage system can be based on a conventional computer architecture, in which the computing resources are separated from the storage resources, and the storage devices perform purely input/output (I/O) processing, e.g., a Von Neumann architecture. As current storage systems expand and grow to a hyperscale infrastructure, this legacy architecture continues to dominate the technical trend. At the same time, increasingly high-performance servers may require that the storage devices provide both low latency and high throughput.

An architecture of a current SSD storage device can include an SSD controller with: a host interface for receiving from a central processing unit (CPU) data to be stored; a memory controller which accesses an internal DRAM; a NAND interface for accessing the NAND flash storage media; and processors which perform computing functions and maintain address-mapping information (e.g., via a flash translation layer or FTL module). However, this current SSD controller architecture is constrained by several factors: migrating large amounts of data between the CPU and the storage device can create a burden on both the CPU and the storage device; the increasing complexity of the CPU cores, bus lanes, and SSDs may exceed the original power budget; it may not be optimal for the CPU to perform the various types of computation required; and because the controller is coupled with the host interface and the storage media, many types of controllers may be required.

Thus, as computing architecture continues to scale, using the conventional storage device controller in a hyperscale infrastructure remains a challenge.

### SUMMARY

One embodiment provides an apparatus for facilitating a hyperscale infrastructure. The apparatus comprises a non-volatile memory and a controller. The controller comprises: a memory interface coupled to a first memory; a media interface coupled to the non-volatile memory; a media controller associated with the media interface; a hardware accelerator configured to process, via the memory interface, data to be written to the non-volatile memory; and a reprogrammable hardware component configured to further process the data via the memory interface. The media controller is configured to write, via the media interface, the data to the non-volatile memory system.

In some embodiments, the controller further comprises a host interface configured to communicate with a host and to receive the first request, and the host comprises a flash translation layer (FTL) for address-mapping. The host interface supports protocols including one or more of: Cache Coherent Interconnect for Accelerators (CCIX); Peripheral Component Interconnect express (PCIe); Gen-Z; Coherent Accelerator Processor Interface (CAPI); and Compute Express Link (CXL).

In some embodiments, the controller further comprises processors configured to perform computations.

In some embodiments, an advanced eXtensibile interface (AXI) bus is configured to provide a connection between the processors, the media controller, and the host interface.

In some embodiments, the processors include one or more of: an intercore control module configured to coordinate multiple cores; an Advanced RISC Machines (ARM) processor or core; a read-only memory (ROM); an interface with one tightly-coupled memory (TCM) port; and an interface with one or two TCM ports. The computations performed by the processors are offloaded from a processing core of a host.

In some embodiments, the controller is configured to receive a first request to write first data to the non-volatile memory. The hardware accelerator and the reprogrammable hardware component are further configured to process, via the memory interface, the first data. The media controller is further configured to write, via the media interface, the processed first data to the non-volatile memory.

In some embodiments, the controller is further configured to receive a second request to read second data from the non-volatile memory, wherein the request includes a physical address for the requested second data. The media controller is further configured to retrieve, via the media interface, the second data from the non-volatile memory based on the included physical address. The hardware accelerator and the reprogrammable hardware component are further configured to process, via the memory interface, the retrieved second data. The processors are further configured to perform a computation on the retrieved second data. The controller is further configured to return, via the host interface, the retrieved data to a requesting host.

In some embodiments, the memory interface is accessed via a universal memory controller. The coupled first memory includes one or more of: dynamic random-access memory (DRAM); resistive random-access memory (ReRAM); and magnetoresistive random-access memory (MRAM).

In some embodiments, the media interface is accessed via the media controller, and the media controller comprises a sequencer, an error correction coding (ECC) codec module, and the hardware accelerator. The non-volatile memory includes one or more of: Not-And (NAND) flash memory; phase change memory (PCM); resistive random-access memory (ReRAM); magnetoresistive random-access memory (MRAM); tape; a hard disk drive (HDD); and any non-volatile memory.

In some embodiments, the hardware accelerator and the reprogrammable hardware component are further configured to process the data to be written to the non-volatile memory based on one or more of: performing a hash calculation on the data; video encoding or video decoding the data; compressing or decompressing the data; encrypting or decrypting the data; erasure code (EC) encoding or decoding the data; and redundant array of independent disks (RAID) encoding or decoding. The computing function is performed by integrating software running on the reprogrammable hardware component with modules on the hardware accelerator component.

Another embodiment provides a system and method for facilitating a hyperscale infrastructure. During operation, the system receives, by a controller of a storage device, a first request to write data to a non-volatile memory, wherein the controller comprises: a memory interface coupled to a memory for temporary low-latency access; a media interface coupled to the non-volatile memory; a media controller associated with the media interface; a hardware accelerator; a reprogrammable hardware component; and processors. The system performs, by the processors, a computation on the data, wherein the computation is offloaded from a processing core of a host. The system processes, by the hardware accelerator and the reprogrammable hardware component via the memory interface, the data to be written to the non-volatile memory. The system writes, by the media controller via the media interface, the data to the non-volatile memory.

In some embodiments, the system receives, by the controller of the storage device, a second request to read the data from the non-volatile memory, wherein the request includes a physical address for the requested data. The system retrieves, via the media interface, the data from the non-volatile memory based on the included physical address. The system processes, by the hardware accelerator and the reprogrammable hardware component via the memory interface, the retrieved data. The system performs, by the processors, a computation on the retrieved data. The system returns the retrieved data to a requesting host.

### BRIEF DESCRIPTION OF THE FIGURES

FIG. 1 illustrates an exemplary architecture of a storage device, in accordance with the prior art.

FIG. 2 illustrates an exemplary environment of a storage device controller, in accordance with an embodiment of the present application.

FIG. 3 illustrates an exemplary high-level design for a storage device controller, in accordance with an embodiment of the present application.

FIG. 4 illustrates an exemplary storage stack, in accordance with an embodiment of the present application.

FIG. 5A illustrates exemplary modules used in a write operation, included as part of a hardware accelerator module in a storage device controller, in accordance with an embodiment of the present application.

FIG. 5B illustrates exemplary modules used in a read operation, included as part of a hardware accelerator module in a storage device controller, in accordance with an embodiment of the present application.

FIG. 6 illustrates a storage device controller with pluggable interfaces for host, memory, and media, in accordance with an embodiment of the present application.

FIG. 7A presents a flowchart illustrating a method for facilitating operation of a storage system, including a write operation, in accordance with an embodiment of the present application.

FIG. 7B presents a flowchart illustrating a method for facilitating operation of a storage system, including a read operation, in accordance with an embodiment of the present application.

FIG. 8 illustrates an exemplary computer system that facilitates operation of a storage system, in accordance with an embodiment of the present application.

FIG. 9 illustrates an exemplary apparatus that facilitates operation of a storage system, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein facilitate a storage system for facilitating a hyperscale infrastructure by using a storage device controller which includes computing resources and compatibility with both next-generation storage media and host buses.

As described above, as computing architecture continues to expand and grow to a hyperscale infrastructure, conventional computer architecture (in which the computing resources are separated from the storage resources and the storage devices perform purely I/O processing, e.g., a Von Neumann architecture), and increasingly high-performance servers may face challenges in providing optimal performance and operating with high efficiency. For example, these high-performance servers may require that the storage devices provide low latency and high throughput. One way in which the current storage systems and servers can meet the critical performance requirements is to reduce the time involved in migrating a large amount of data.

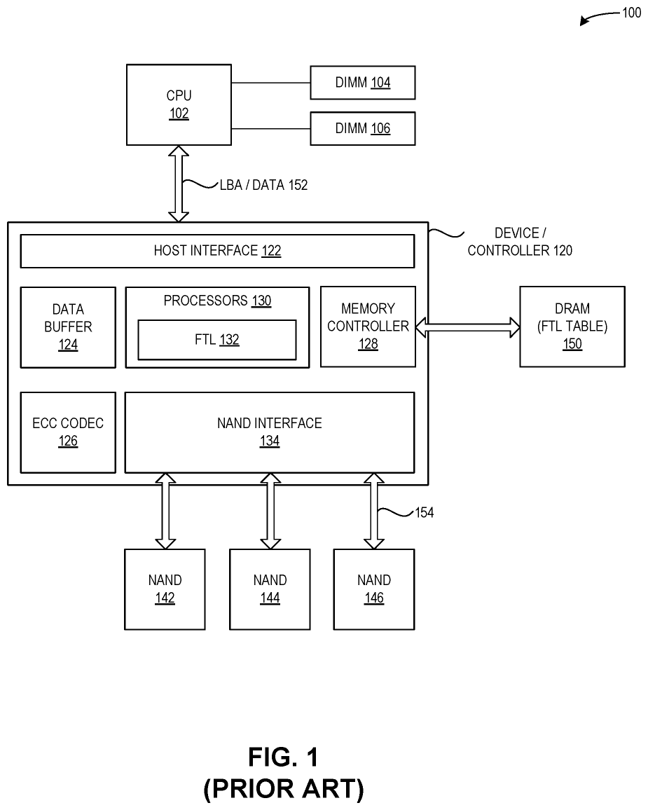

A conventional SSD storage device architecture can include an SSD controller with: a host interface for receiving from a central processing unit (CPU) data to be stored; a memory controller which accesses an internal DRAM; a NAND interface for accessing the NAND flash storage media; and processors which perform computing functions and maintain address-mapping information, (e.g., via a flash translation layer or FTL module). However, this current SSD controller architecture is constrained by several factors: migrating large amounts of data between the CPU and the storage device can create a burden on both the CPU and the storage device; the increasing complexity of the CPU cores, bus lanes, and SSDs may exceed the original power budget; it may not be optimal for the CPU to perform the various types of computation required; and because the controller is coupled with the host interface and the storage media, many types of controllers may be required. An exemplary conventional SSD storage device is described below in relation to FIG. 1.

Thus, as computing architecture continues to scale, using the conventional storage device controller in a hyperscale infrastructure remains a challenge.

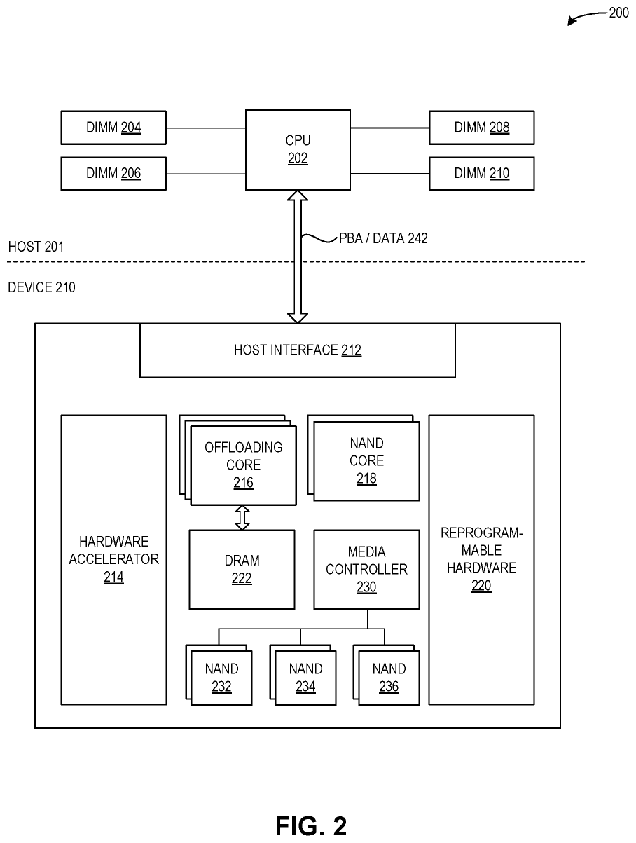

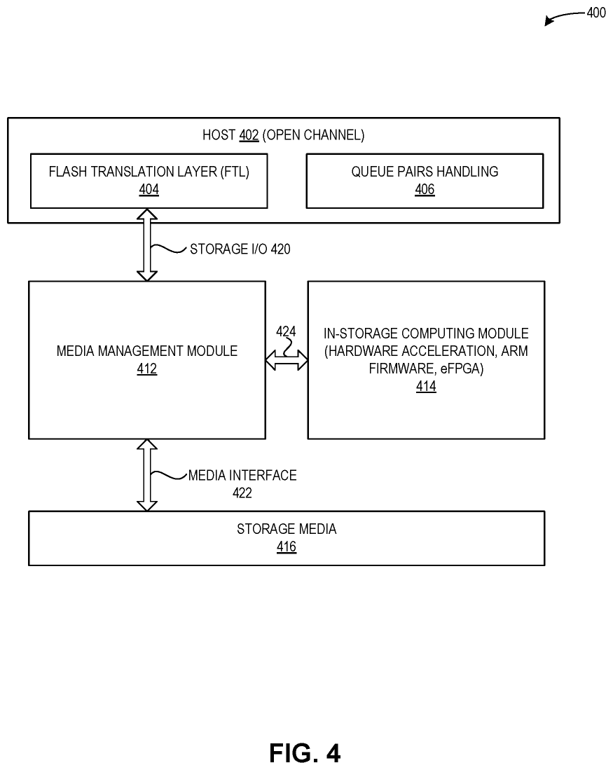

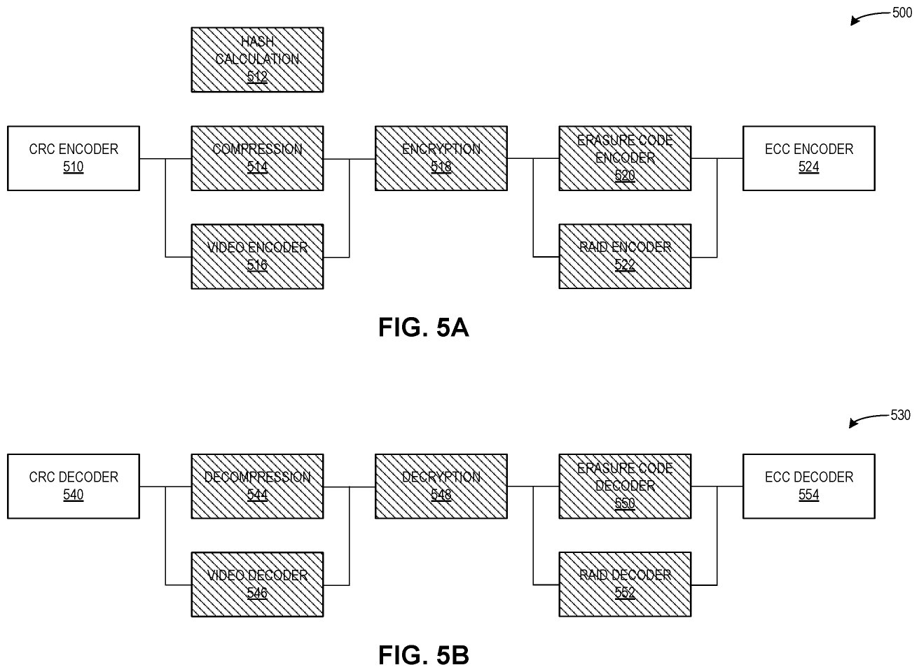

The embodiments described herein address these limitations by providing a system with an architecture and design for a storage device controller. The controller can include computing resources and compatibility with both next-generation storage media and host buses (e.g., via pluggable host, media, and memory interfaces, as described below in relation to FIGS. 2, 3, and 6). The address-mapping functions performed by the flash translation layer (FTL) can be moved to the host, which allows the FTL to operate on the host CPU and associated dual in-line memory modules (DIMMs). The controller can also include NAND cores (which can perform management of the storage media, software, retry, etc.) and off-loading cores (which can accomplish the computing processes offloaded from the host CPU cores). The controller can further include a hardware accelerator (which can perform common and basic processing with improved efficiency, as described below in relation to FIG. 5) and reprogrammable hardware (which can be variously configured to provide in-situ computing to handle various application scenarios). An exemplary architecture for a storage device controller is described below in relation to FIGS. 2, 3, and 6, and an exemplary storage stack is described below in relation to FIG. 4.

Thus, in the embodiments described herein, the architecture of the system can provide a more efficient and improved overall system to support the continuing expansion of computer and storage architecture to a hyperscale infrastructure, by: using flexible and pluggable host, memory, and media interfaces; providing in-storage computing with hardware accelerators, reprogrammable hardware modules, and competent offloading cores; and converging applications with storage management (e.g., FTL).

A “storage system infrastructure,” “storage infrastructure,” or “storage system” refers to the overall set of hardware and software components used to facilitate storage for a system. A storage system can include multiple clusters of storage servers and other servers. A “storage server” refers to a computing device which can include multiple storage devices or storage drives. A “storage device” or a “storage drive” refers to a device or a drive with a non-volatile memory which can provide persistent storage of data, e.g., a solid state drive (SSD), a hard disk drive (HDD), or a flash-based storage device. Other types of non-volatile memory can include: NAND; phase change memory (PCM); resistive random-access memory (ReRAM); magnetoresistive random-access memory (MRAM); tape; and platters of a hard disk drive.

A “computing architecture,” “computer architecture,” or “computing environment” refers to a description of the functionality, organization, and implementation of computer systems. A computing architecture can include certain types of storage systems, and a storage system can be based on a certain type of computing architecture.

A “hyperscale infrastructure” refers to a system with the ability to scale based on increased demand, including adding compute, memory, networking, and storage resources to nodes which are part of a larger computing architecture or environment.

A “computing device” refers to any server, device, node, entity, drive, or any other entity which can provide any computing capabilities.

### Exemplary Architecture of a Storage Device in the Prior Art

FIG. 1 illustrates an exemplary architecture 100 of a storage device, in accordance with the prior art. Architecture 100 can include a host with a central processing unit (CPU) 102 and dual in-line memory modules (DIMMs) 104 and 106. CPU 102 can transmit data associated with an input/output (I/O) request and a corresponding logical block address for the data (e.g., LBA/data 152) to a device/controller 120. Device/controller 120 can be a solid state drive (SSD) or a controller of a storage drive. Device/controller 120 can include: a host interface 122 which communicates with CPU 102; a data buffer 124; an error correction code (ECC) codec 126; a memory controller 128, which communicates with a DRAM 150 for storing and maintaining a flash translation layer (FTL) mapping table; processors 130, including an FTL module 132 for managing address-mapping between the received LBA (e.g., 152) and a corresponding physical address in the non-volatile memory at which the data is to be written or from which the data is to be retrieved; and a NAND interface 134, which communicates with storage media, e.g., the non-volatile memory of NANDs 142, 144, and 146.

In device/controller 120, the system can store the address-mapping information associated with the FTL table in internal DRAM (i.e., 150), which can allow for a lower latency in accessing the FTL table to perform read and write operations. Processors 130 can include software or firmware to handle all behavior or operations associated with the device (i.e., device/controller 120). As a result, as the design of device/controller 120 becomes more complicated, device/controller 120 may still only be designed to provide functionality for read and write operations.

This current SSD controller architecture is constrained by several factors. First, migrating large amounts of data between the CPU (e.g., CPU 102) and the storage device (e.g., device 120) can create a burden on both the CPU and the storage device. The system must spend CPU resources on handling interrupt responses or responding to consistent polling operations. Thus, the SSD controller is overdesigned and, because it is generally replaced on a frequent basis with newer controllers (e.g., new generation controllers), each generation may only be used for a short cycle. This can result in a decrease in the efficiency of usage and a higher total cost of operation (TCO).

Second, the increasing complexity of the CPU cores, bus lanes, and SSDs may exceed the original power budget. Third, because the CPU is required to perform various types of computations, it may not be optimal for the CPU to perform these various types of computations.

Fourth, because the controller is coupled with the host interface and the storage media, many types of controllers may be required. This can result in an increased TCO due to the limited volume of integrated circuits by diversified products.

Thus, all of these constraints associated with the conventional storage device controller can limit the flexibility, performance, growth, and scalability of a hyperscale infrastructure.

### Exemplary Storage Device Controller

FIG. 2 illustrates an exemplary environment 200 of a storage device controller, in accordance with an embodiment of the present application. Environment 200 can include a host 201 and a device 210. Host 201 can include a CPU 202 and DIMMs 204, 206, 208, and 210. Device 210, which can represent a controller, can include: a host interface 212; a hardware accelerator 214; an offloading core 216; DRAM 222; a NAND core 218; a media controller 230 configured to communicate with storage media, such as NANDs 232, 234, and 236; and reprogrammable hardware 220.

In environment 200, the storage stack can be moved to the host side using an open-channel technique, which allows the flash translation layer (FTL) to operate on the host CPU and DIMMs (e.g., 202 and 204-210, respectively). Thus, device 210 or device controller 210 does not comprise or include a flash translation layer (FTL); instead, the FTL address-mapping functions are performed by the host via CPU 202 and DIMMs 204-210. Furthermore, offloading core 216 can perform computations which are offloaded from CPU 202 and can use an internal DRAM 222 as a memory for temporary low-latency access for performing the necessary computations.

After an open channel driver executes the flash translation layer (on the host 201 side), device 210 can perform storage functions using firmware installed on NAND core 218, e.g., NAND characterization management, software retry, etc. Because offloading core 216 can execute the offloaded computations from CPU 202, NAND core 218 can include a processor with more relaxed performance requirements. Offloading core 216 can include a strong or a fast processor with sufficient computing capability to meet the necessary requirements. The system can also develop the corresponding software running on offloading core 216 along with the performance tuning of the overall storage device 210.

Hardware accelerator 214 can be a component which includes a set of hardware module to execute common and basic processing with an improved efficiency. Hardware accelerator 214 (via, e.g., its hardware modules) can be configured to process data via a memory interface. Exemplary modules in a hardware accelerator can include compression/decompression modules, encryption/decryption modules, and an erasure code (EC) code, as described below in relation to FIG. 5.

Reprogrammable hardware 220 can include an embedded field-programmable gate array (eFPGA), which, similar to hardware accelerator 214, can also process data via a memory interface. The eFPGA can be configured using different logic designs to provide in-situ computing for various application scenarios. The reprogrammability of the hardware allows the system (e.g., device or controller 210) to use the same hardware to serve multiple applications during a mass deployment.

Furthermore, the system of environment 200 can integrate software running on the embedded microprocessor (e.g., offloading core 216), the eFPGA (e.g., reprogrammable hardware 220), and the hardware computing modules (e.g., hardware accelerator 214) in order to achieve a wide spectrum of computing functions and computing capacity. By including the elements described in relation to environment 200 for device 210, the embodiments described herein can provide an improvement in the performance and efficiency of the overall storage system, which can further facilitate a growing and expanding hyperscale infrastructure for a computing or storage architecture.

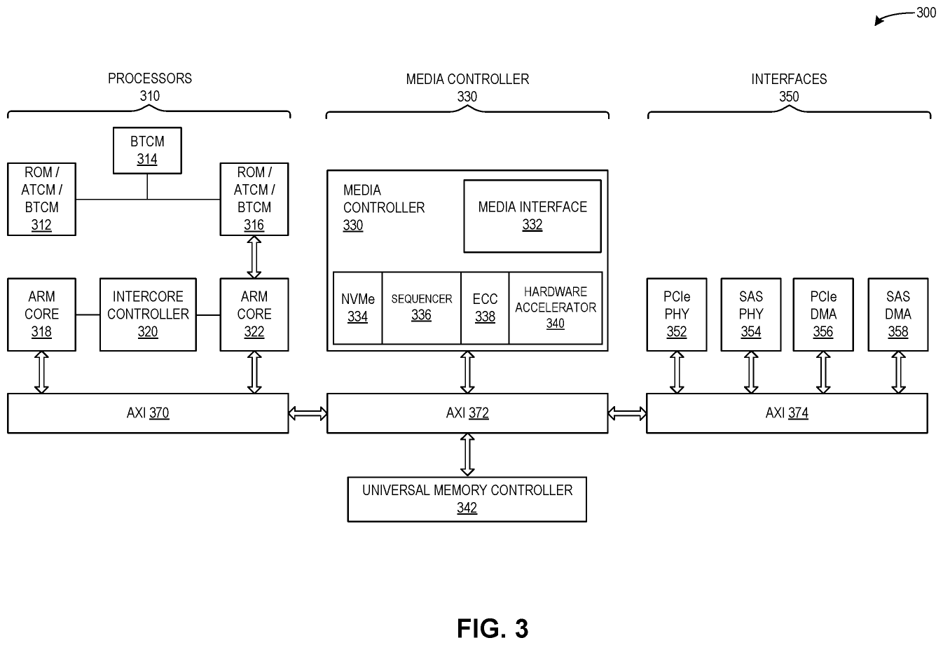

FIG. 3 illustrates an exemplary high-level design 300 for a storage device controller, in accordance with an embodiment of the present application. Design 300 can include three categories of components, modules, units, or functionality: processors 310; a media controller 330; and interfaces 350. As an example, processors 310 can include: an intercore controller 320 configured to coordinate multiple cores; multiple ARM cores 318 and 322; and a read-only memory (ROM)/A tightly-coupled memory (ATCM)/B tightly-coupled memory (BTCM) interface 312, a BTCM 314, and a ROM/ATCM/BTCM 316, which can communicate with one or more ARM cores (e.g., ARM core 322). An ATCM can be an interface with one TCM port, and a BTCM can be an interface with one or more TCM ports. BTCMs 312-316 can be shared for the data which is used by the multiple cores.

Media controller 330 can include: a media interface 332; a non-volatile memory (NVMe) 334; a sequencer 336; an error correction (ECC) codec 338; and a hardware accelerator 340. Media controller 330 can correspond to media controller 230 of FIG. 2; NVMe 334 can correspond to NANDs 232-236 of FIG. 2; and hardware accelerator 340 can correspond to hardware accelerator 214 of FIG. 2. Media controller 330 can thus be characterized as densely implemented logic for data-intensive processing, as described above in relation to the processing performed by hardware accelerator 214 in FIG. 2 and the hardware modules of a hardware accelerator as described below in relation to FIG. 5.

Interfaces 350 can include support for a host interface which can be configured to communicate with hosts or applications via, e.g.,: a Peripheral Component Interconnect express (PCIe) physical layer (PHY) 352; a Serial Attached SCSI (SAS) PHY 354; a PCIe direct memory access (DMA) 356; and an SAS DMA 358.

In design 300, an advanced eXtensibile interface (AXI) bus is configured to provide a connection between the processors, the media controller, and the host interface. The AXI bus can be divided into multiple instantiations in order to ensure the time closure for the high-speed circuit, e.g.: an AXI 370 can be configured to handle communications from processors 310; an AXI 372 can be configured to handle communications from media controller 330; and an AXI 374 can be configured to handle communications via interfaces 350.

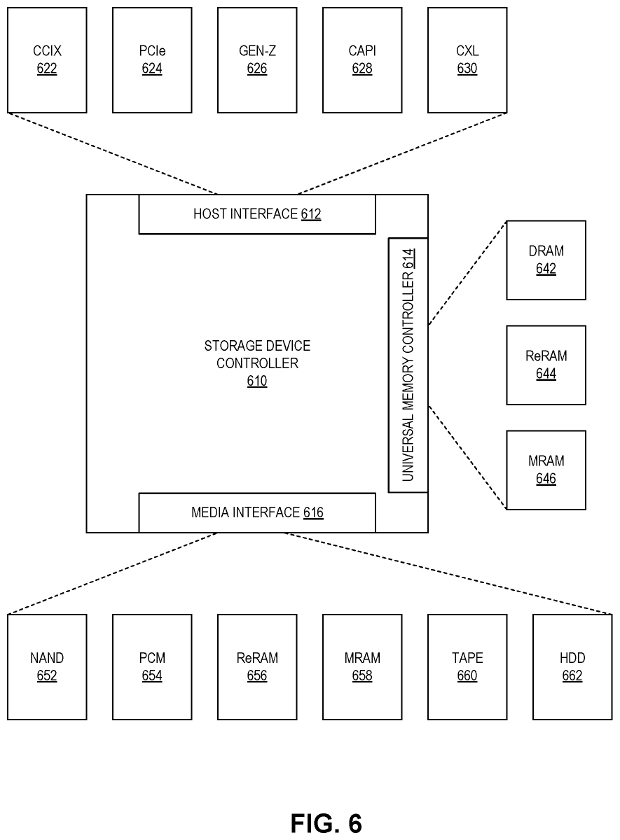

Furthermore, a universal memory controller 342 can be configured to provide access to a memory for temporary low-latency access, e.g., via a double data rate (DDR) protocol and an AXI 372, as described below in relation to FIG. 6.

### Exemplary Storage Stack

FIG. 4 illustrates an exemplary storage stack 400, in accordance with an embodiment of the present application. In storage stack 400, the storage management is moved to the host side, and the in-storage computing can be performed using the hardware and software described herein. A host 402 (using an open-channel protocol) can include a flash translation layer (FTL) 404 and a queue pairs handling module 406. Data can be transmitted as a storage I/O 420 from host 402 to a media management module 412 of a storage device (e.g., corresponding to media controller 330 of FIG. 3). Storage I/O 420 can be a request which includes a physical block address (e.g., as assigned by host-based FTL 404 of host 402), associated data, and a computation request. Media management module 412 can transmit to an in-storage computing module 414 any data on which further processing or computations need to be performed (via a communication 424).

Module 414 can include a hardware accelerator, ARM firmware, and an eFPGA. The hardware accelerator (e.g., hardware accelerator 214 of FIG. 2) can include a logic circuit in an ASIC, and can be used for computation and processing of data. This ASIC module can be designed to handle various functions, e.g., read, hash, compression, etc., as described below in relation to FIGS. 5A and 5B. The ARM firmware (e.g., offloading core 216 and NAND core 218 of FIG. 2) can be implemented as embedded programs running on microprocessors, which can complete or finish certain processing of data. The eFPGA (e.g., reprogrammable hardware 220 of FIG. 2) can be a module on which the logic circuit is designed and resides, and can realize certain logic functions. Both the ARM firmware and the eFPGA can be reconfigured, e.g., by reprogramming the ARM firmware or modifying the design of eFPGA. An exemplary hardware accelerator, ARM firmware, and eFPGA are described above in relation to FIGS. 2 and 3.

Media management module 412 can further transmit any data (including data processed by in-storage module 414 and returned via communication 424) to storage media 416 (via a media interface 422).

By placing the data-intensive computation physically close to where the data is stored or is to be stored, the system can perform computation and processing for data which is to be stored or retrieved from storage media 416 (e.g., by in-storage computing module 414). The system can further retrieve and return requested data or computation results (performed by in-storage computing module 414) to a requesting host, and can also store incoming processed data (processed by in-storage computing module 414) in storage media 416.

Moreover, the system can be optimized by using a log-structured distributed file system (DFS), which can avoid the multiple folds of write amplification from DFS compaction and SSD garbage collection. This optimization can also occur between the applications and the storage devices. This allows the system to handle the storage I/O at the host side with a simplified stack and an improved efficiency.

### Hardware Accelerator Modules

FIG. 5A illustrates exemplary modules 500 used in a write operation, included as part of a hardware accelerator module in a storage device controller, in accordance with an embodiment of the present application. In a typical write operation, data may be transmitted through and processed by the following modules: a cyclic redundancy check (CRC) encoder module 510; a hash calculation module 512; a compression module 514; a video encoder module 516; an encryption module 518; an erasure code (EC) encoder module 520; a redundant array of independent disks (RAID) encoder module 522; and an error correction code (ECC) encoder module 524. In the embodiments described here, the modules depicted as filled in with left-slanting diagonal lines can be included as modules in the hardware accelerator (e.g., in hardware accelerator 214 of FIG. 2, hardware accelerator 340 of FIG. 3, and in-storage computing module 414 of FIG. 4). That is, the hardware accelerator of the described embodiments can include modules for hash calculation, compression, video encoding, encryption, EC encoding, and RAID encoding (i.e., modules 512-522).

FIG. 5B illustrates exemplary modules 530 used in a read operation, included as part of a hardware accelerator module in a storage device controller, in accordance with an embodiment of the present application. In a typical read operation, data may be transmitted through and processed by the following modules: a cyclic redundancy check (CRC) decoder module 540; a decompression module 544; a video decoder module 546; an decryption module 548; an erasure code (EC) decoder module 550; a redundant array of independent disks (RAID) decoder module 552; and an error correction code (ECC) decoder module 554. In the embodiments described here, the modules depicted as filled in with left-slanting diagonal lines can be included as modules in the hardware accelerator (e.g., in hardware accelerator 214 of FIG. 2, hardware accelerator 340 of FIG. 3, and in-storage computing module 414 of FIG. 4). That is, the hardware accelerator of the described embodiments can include modules for decompression, video decoding, decryption, EC decoding, and RAID decoding (i.e., modules 544-552).

Thus, by placing these modules described above in FIGS. 5A and 5B into the hardware accelerator of the storage device controller, the embodiments described herein can provide functionality to meet the daily demands to accelerate the necessary (and frequently used) operations by making use of the high-efficiency integrated circuits of the hardware accelerator.

Exemplary Storage Device Controller with Pluggable Interfaces

Examples of current server platforms can include X-86, ARM, and Power. As described above, the development of the storage device has been limited by many constraints, including the host bus. As a result, the storage device may not be able to maintain pace with the growing and expanding evolution of the network and computer architecture (e.g., in a hyperscale infrastructure), and instead can become a throughput bottleneck in certain servers.

The embodiments described herein solve this server adoption issue by providing a controller which can serve as a bridge between the various applications and the new-generation storage media. FIG. 6 illustrates a storage device controller 610 with pluggable interfaces for host, memory, and media, in accordance with an embodiment of the present application. Controller 610 can include three pluggable interfaces which facilitate an agile and flexible architecture to enable new-generation storage media and various host platforms (e.g., diversified host products).

Controller 610 can include the following three interfaces: a host interface 612; a universal memory controller 614; and a media interface 616. Host interface 612 can support various protocols, such as: a Cache Coherent Interconnect for Accelerators (CCIX) 622; a Peripheral Component Interconnect express (PCIe) 624; a Gen-Z 626; a Coherent Accelerator Processor Interface (CAPI) 628; and a Compute Express Link (CXL) 630. Host interface 612 can be used to communicate with the CPU and a network interface card (NIC) (not shown). Thus, host interface 612 can provide an interface for various protocols with low latency and high efficiency, e.g., by supporting and using different protocols but the same PCIe PHY (the same physical PHY layer), as depicted above in relation to FIG. 3.

Universal memory controller 614 can correspond to universal memory controller 342 of FIG. 3 and to a memory interface (not shown) between offloading core 216 and DRAM 222 of FIG. 2. Universal memory controller 614 or the memory interface described herein can be coupled to a memory for temporary low-latency access, and the coupled memory can include, e.g.: a DRAM 642; a ReRAM 644; and an MRAM 646. This coupled memory can be volatile or non-volatile, and can be used to store data and provide temporary low-latency access for computations performed by the in-storage computing modules (e.g., as described above in relation to in-storage computing module 414 of FIG. 4). The low-latency access may correspond to an access latency which is below a certain predetermined threshold.

Media interface 616 can correspond to: a media interface (not shown) between media controller 230 and NANDs 232-236 of FIG. 2; media interface 332 of media controller 330 of FIG. 3; and media interface 422 of FIG. 4. Media interface 616 can be coupled to non-volatile memory, such as: NAND 652; PCM 654; ReRAM 656; MRAM 658; tape 660; and a hard disk drive (HDD) 662). Media interface 616 can be used to control the storage media (e.g., storage media 416 of FIG. 4 and the above described non-volatile memory 652-662) to ensure high reliability while executing I/O (e.g., read/write) operations.

### Method for Facilitating Operation of a Storage System

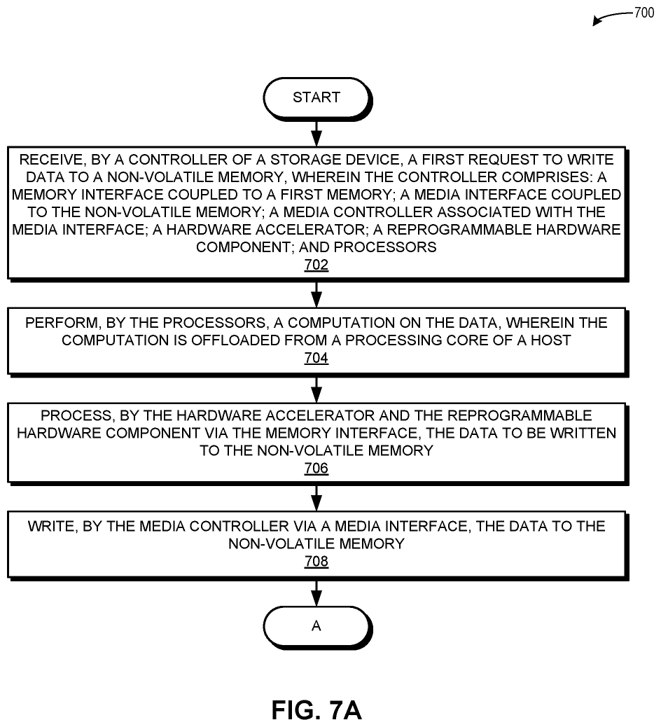

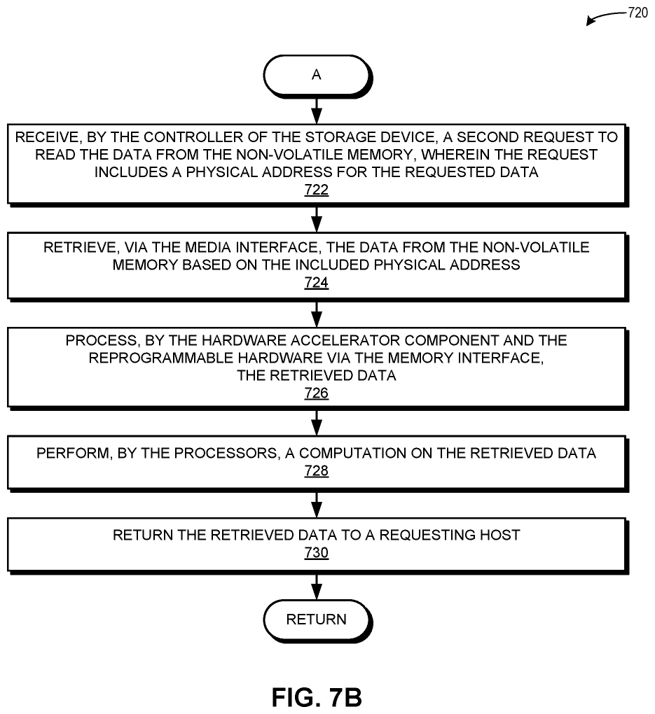

FIG. 7A presents a flowchart 700 illustrating a method for facilitating operation of a storage system, including a write operation, in accordance with an embodiment of the present application. During operation, the system receives, by a controller of a storage device, a first request to write data to a non-volatile memory, wherein the controller comprises: a memory interface coupled to a first memory; a media interface coupled to the non-volatile memory; a media controller associated with the media interface; a hardware accelerator; a reprogrammable hardware component; and processors (operation 702). The coupled first memory can provide a temporary, low-latency access, e.g., for storing data associated with computations performed by one or more of the hardware accelerator, the reprogrammable hardware component, and the processors. The coupled first memory can include volatile and non-volatile memory, e.g., DRAM, ReRAM, and MRAM, as described above in relation to FIG. 6. The system performs, by the processors, a computation on the data, wherein the computation is offloaded from a processing core of a host (operation 704). The system processes, by the hardware accelerator and the reprogrammable hardware component via the memory interface, the data to be written to the non-volatile memory (operation 706). The system writes, by the media controller via the media interface, the data to the non-volatile memory (operation 708). The operation continues as described at Label A of FIG. 7B.

FIG. 7B presents a flowchart 720 illustrating a method for facilitating operation of a storage system, including a read operation, in accordance with an embodiment of the present application. During operation, the system receives, by the controller of the storage device, a second request to read the data from the non-volatile memory, wherein the request includes a physical address for the requested data (operation 722). The system retrieves, via the media interface, the data from the non-volatile memory based on the included physical address (operation 724). In some embodiments, data the requested in the second request is the same as the data previously stored in the non-volatile memory (i.e., operation 708) as part of executing the received first request to write data to the non-volatile memory (i.e., operation 702). The system processes, by the hardware accelerator and the reprogrammable hardware component via the memory interface, the retrieved data (operation 726). The system performs, by the processors, a computation on the retrieved data (operation 728). The system returns the retrieved data to a requesting host (operation 730), and the operation returns.

### Exemplary Computer System and Apparatus

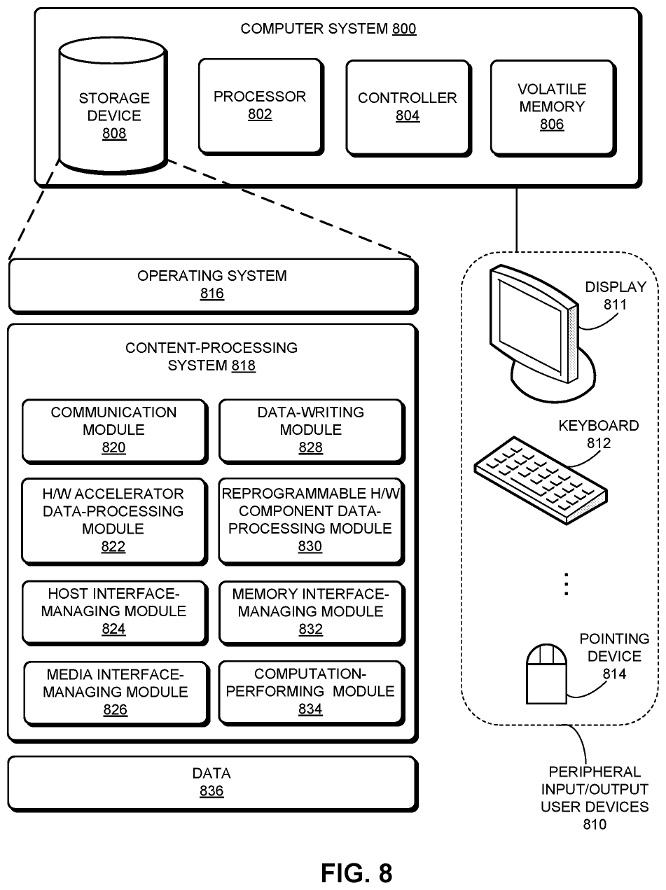

FIG. 8 illustrates an exemplary computer system that facilitates operation of a storage system, in accordance with an embodiment of the present application. Computer system 800 includes a processor 802, a controller 804, a volatile memory 806, and a storage device 808. Volatile memory 806 can include, e.g., random access memory (RAM), that serves as a managed memory, and can be used to store one or more memory pools. Storage device 808 can include persistent storage which can be managed or accessed via processor 802 or controller 804. Controller 804 can correspond to device/controller 210 of FIG. 2, modules 412 and 414 of FIG. 4, and controller 610 of FIG. 6, i.e., controller 804 can include its own processors, a hardware accelerator, and a reprogrammable hardware component. Furthermore, computer system 800 can be coupled to peripheral input/output (I/O) user devices 810, e.g., a display device 811, a keyboard 812, and a pointing device 814. Storage device 808 can store an operating system 816, a content-processing system 818, and data 836. In some embodiments, instruction included in content-processing 818 can be programmed as software or firmware into the hardware modules of controller 804.

Content-processing system 818 can include instructions, which when executed by computer system 800, can cause computer system 800 or processor 802 to perform methods and/or processes described in this disclosure. Specifically, content-processing system 818 can include instructions for receiving and transmitting data packets, including data to be read or written and an input/output (I/O) request (e.g., a read request or a write request) (communication module 820).

Content-processing system 818 can further include instructions for receiving, by a controller of a storage device, a first request to write data to a non-volatile memory, wherein the controller comprises: a memory interface coupled to a first memory; a media interface coupled to the non-volatile memory; a media controller associated with the media interface; a hardware accelerator; a reprogrammable hardware component; and processors (communication module 820 and host interface-managing module 824). Content-processing system 818 can include instructions for performing, by the processors, a computation on the data, wherein the computation is offloaded from a processing core of a host (computation-performing module 834). Content-processing system 818 can also include instructions for processing, by the hardware accelerator and the reprogrammable hardware component via the memory interface, the data to be written to the non-volatile memory (hardware accelerator data-processing module 822, reprogrammable hardware component data-processing module 830, and memory interface-managing module 832). Content-processing system 818 can include instructions for writing, by the media controller via the media interface, the data to the non-volatile memory (data-writing module 828 and media interface-managing module 826).

Data 836 can include any data that is required as input or generated as output by the methods and/or processes described in this disclosure. Specifically, data 836 can store at least: data; a request; a read request; a write request; an input/output (I/O) request; data or metadata associated with a read request, a write request, or an I/O request; a physical address or a physical block address (PBA); a logical address or a logical block address (LBA); an indicator or identifier of a host interface, a memory interface, or a media interface; an indicator or identifier of an application or protocol type; an indicator or identifier of a processor, a volatile memory, or a non-volatile memory; a mapping table; an indicator of a host bus or multiple instantiations of the host bus; and an indicator or identifier of a hardware accelerator, an offloading core, a volatile memory, a NAND core, a media controller, a non-volatile physical memory or storage media, a reprogrammable hardware component, a memory for temporary low-latency access, a host interface, a media interface, a memory interface, and a universal memory controller.

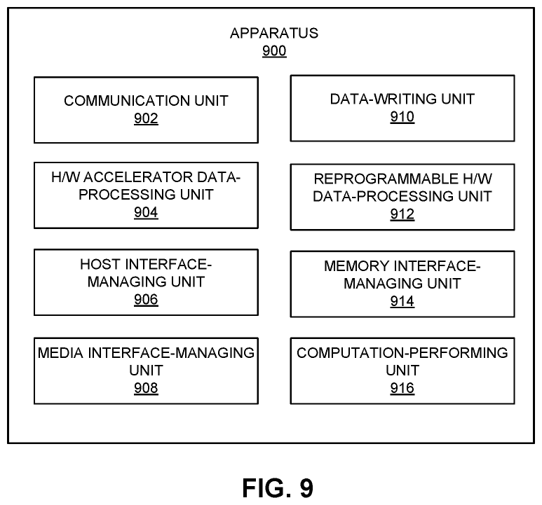

FIG. 9 illustrates an exemplary apparatus 900 that facilitates operation of a storage system, in accordance with an embodiment of the present application. Apparatus 900 can comprise a plurality of units or apparatuses which may communicate with one another via a wired, wireless, quantum light, or electrical communication channel. Apparatus 900 may be realized using one or more integrated circuits, and may include fewer or more units or apparatuses than those shown in FIG. 9. Furthermore, apparatus 900 may be integrated in a computer system, or realized as a separate device or devices capable of communicating with other computer systems and/or devices. Apparatus 800 can correspond to a storage device with a storage controller, such as device/controller 210 of FIG. 2.

Apparatus 900 can comprise modules or units 902-916 which are configured to perform functions or operations similar to modules 820-834 of computer system 800 of FIG. 8, including: a communication unit 902; a hardware accelerator data-processing unit 904; a host interface-managing unit 906; a media interface-managing unit 908; a data-writing unit 910; a reprogrammable hardware data-processing unit 912; a memory interface-managing unit 914; and a computation-performing unit 916.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. An apparatus, comprising:
a non-volatile memory; and
a controller, which comprises:
a memory interface coupled to a first memory;
a media interface coupled to the non-volatile memory;
a media controller associated with the media interface;
a hardware accelerator configured to process, via the memory interface, data to be written to the non-volatile memory; and
a reprogrammable hardware component configured to further process the data via the memory interface;
wherein the media controller is configured to write, via the media interface, the data to the non-volatile memory.

2. The apparatus of claim 1,
wherein the controller further comprises a host interface configured to communicate with a host and to receive the first request,
wherein the host comprises a flash translation layer (FTL) for address-mapping, and
wherein the host interface supports protocols including one or more of:
Cache Coherent Interconnect for Accelerators (CCIX);
Peripheral Component Interconnect express (PCIe);
Gen-Z;
Coherent Accelerator Processor Interface (CAPI); and
Compute Express Link (CXL).

3. The apparatus of claim 2,
wherein the controller further comprises processors configured to perform computations.

4. The apparatus of claim 3,
wherein an advanced eXtensibile interface (AXI) bus is configured to provide a connection between the processors, the media controller, and the host interface.

5. The apparatus of claim 3, wherein the processors include one or more of:
an intercore control module configured to coordinate multiple cores;
an Advanced RISC Machines (ARM) processor or core;
a read-only memory (ROM);
an interface with one tightly-coupled memory (TCM) port; and
an interface with one or two TCM ports,
wherein the computations performed by the processors are offloaded from a processing core of a host.

6. The apparatus of claim 3,
wherein the controller is configured to receive a first request to write first data to the non-volatile memory,
wherein the hardware accelerator and the reprogrammable hardware component are further configured to process, via the memory interface, the first data, and
wherein the media controller is further configured to write, via the media interface, the processed first data to the non-volatile memory.

7. The apparatus of claim 3,
wherein the controller is further configured to receive a second request to read second data from the non-volatile memory, wherein the request includes a physical address for the requested second data,
wherein the media controller is further configured to retrieve, via the media interface, the second data from the non-volatile memory based on the included physical address,
wherein the hardware accelerator and the reprogrammable hardware component are further configured to process, via the memory interface, the retrieved second data,
wherein the processors are further configured to perform a computation on the retrieved second data, and
wherein the controller is further configured to return, via the host interface, the retrieved data to a requesting host.

8. The apparatus of claim 1,
wherein the memory interface is accessed via a universal memory controller, and
wherein the coupled first memory includes one or more of:
dynamic random-access memory (DRAM);
resistive random-access memory (ReRAM); and
magnetoresistive random-access memory (MRAM).

9. The apparatus of claim 1,
wherein the media interface is accessed via the media controller,
wherein the media controller comprises a sequencer, an error correction coding (ECC) codec module, and the hardware accelerator, and
wherein the non-volatile memory includes one or more of:
Not-And (NAND) flash memory;
phase change memory (PCM);
resistive random-access memory (ReRAM);
magnetoresistive random-access memory (MRAM);
tape;
a hard disk drive (HDD); and
any non-volatile memory.

10. The apparatus of claim 1, wherein the hardware accelerator and the reprogrammable hardware component are further configured to process the data to be written to the non-volatile memory based on one or more of:
performing a hash calculation on the data;
video encoding or video decoding the data;
compressing or decompressing the data;
encrypting or decrypting the data;
erasure code (EC) encoding or decoding the data; and
redundant array of independent disks (RAID) encoding or decoding,
wherein the computing function is performed by integrating software running on the reprogrammable hardware component with modules on the hardware accelerator component.

11. A computer-implemented method, comprising:
receiving, by a controller of a storage device, a first request to write data to a non-volatile memory,
wherein the controller comprises:
a memory interface coupled to a first memory;
a media interface coupled to the non-volatile memory;
a media controller associated with the media interface;
a hardware accelerator; and
a reprogrammable hardware component;
processing, by the hardware accelerator and the reprogrammable hardware component via the memory interface, the data to be written to the non-volatile memory; and
writing, by the media controller via the media interface, the data to the non-volatile memory.

12. The method of claim 11,
wherein the controller further comprises a host interface configured to communicate with a host and to receive the first request,
wherein the host comprises a flash translation layer (FTL) for address-mapping, and
wherein the host interface supports protocols including one or more of:
Cache Coherent Interconnect for Accelerators (CCIX);
Peripheral Component Interconnect express (PCIe);
Gen-Z;
Coherent Accelerator Processor Interface (CAPI); and
Compute Express Link (CXL).

13. The method of claim 12,
wherein the controller further comprises processors configured to perform computations.

14. The method of claim 13,
wherein an advanced eXtensibile interface (AXI) bus is configured to provide a connection between the processors, the media controller, and the host interface.

15. The method of claim 13, wherein the processors include one or more of:
an intercore control module configured to coordinate multiple cores;
an Advanced RISC Machines (ARM) processor or core;
a read-only memory (ROM);
an interface with one tightly-coupled memory (TCM) port; and
an interface with one or two TCM ports,
wherein the computations performed by the processors are offloaded from a processing core of a host.

16. The method of claim 13, further comprising:
receiving, by the controller of the storage device, a second request to read the data from the non-volatile memory, wherein the request includes a physical address for the requested data;
retrieving, via the media interface, the data from the non-volatile memory based on the included physical address;
processing, by the hardware accelerator and the reprogrammable hardware component via the memory interface, the retrieved data;
performing, by the processors, a computation on the retrieved data; and
returning the retrieved data to a requesting host.

17. The method of claim 11,
wherein the memory interface is accessed via a universal memory controller, and
wherein the coupled first memory includes one or more of:
dynamic random-access memory (DRAM);
resistive random-access memory (ReRAM); and
magnetoresistive random-access memory (MRAM).

18. The method of claim 11,
wherein the media interface is accessed via the media controller,
wherein the media controller comprises a sequencer, an error correction coding (ECC) codec module, and the hardware accelerator, and
wherein the non-volatile memory includes one or more of:
Not-And (NAND) flash memory;
phase change memory (PCM);
resistive random-access memory (ReRAM);
magnetoresistive random-access memory (MRAM);
tape;
a hard disk drive (HDD); and
any non-volatile memory.

19. The method of claim 11, wherein processing the data by the hardware accelerator component and the reprogrammable hardware component comprises one or more of:
performing a hash calculation on the data;
video encoding or video decoding the data;
compressing or decompressing the data;
encrypting or decrypting the data;
erasure code (EC) encoding or decoding the data; and
redundant array of independent disks (RAID) encoding or decoding,
wherein the computing function is performed by integrating software running on the reprogrammable hardware component with modules on the hardware accelerator component.

20. A computer system, comprising:
a processor; and
a memory coupled to the processor and storing instructions which, when executed by the processor, cause the processor to perform a method, the method comprising:
receiving, by a controller of a storage device, a first request to write data to a non-volatile memory,
wherein the controller comprises:
a memory interface coupled to a first memory;
a media interface coupled to the non-volatile memory;
a media controller associated with the media interface;
a hardware accelerator;
a reprogrammable hardware component; and
processors;
performing, by the processors, a computation on the data, wherein the computation is offloaded from a processing core of a host;
processing, by the hardware accelerator and the reprogrammable hardware component via the memory interface, the data to be written to the non-volatile memory; and
writing, by the media controller via the media interface, the data to the non-volatile memory.
